(19) United States
(12) Patent Application Publication
(10) Pub. No.: US 2007/0061703 A1
(43) Pub. Date: Mar. 15, 2007

(54) Method and apparatus for annotating a document

(75) Inventors: Nandakishore Kambhatla, White Plains, NY (US); Salim Estephan Roukos, Scarsdale, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/224,171

(22) Filed: Sep. 12, 2005

(51) Int. Cl. G06F 17/00

(52) U.S. Cl. 715/512

(57) ABSTRACT

Methods and apparatus are provided for annotating documents with one or more of entities, events and relations. Documents are annotated by presenting the document to a user; presenting the user with a list of possible entity types, wherein the list of possible entity types is configurable; and obtaining at least one mention annotation that associates a selected phrase in the document with one of the possible entity types. The selected phrase can be presented to the user, for example, based on one or more presentation rules associated with the associated entity type. The method can be implemented, for example, in a client-server configuration where a browser communicates with a remote server. A document can also be annotated by presenting the document to a user; presenting the user with a list of possible relation types, wherein the list of possible relation types is configurable; receiving at least two mention annotations from the user that each associate a selected phrase in the document with a entity type; and obtaining a relation annotation, wherein the relation annotation specifies a relation type between the at least two mention annotations.

### FIELD OF THE INVENTION

The present invention relates generally to techniques for annotating information about documents, and more particularly, to annotating documents with entities, events and relations

### BACKGROUND OF THE INVENTION

Automated analysis of documents has become a popular tool for dealing with ever increasing volumes of documents in multiple languages, formats, and genres. Analysis techniques include automated methods for categorization, summarization, extraction of information, clustering and indexing information (for search). Such techniques typically rely on corpora of documents manually annotated with information that are used to train statistical models for achieving the automation.

A number of techniques have been proposed or suggested for annotating relations and entities in documents. Generally, such techniques allow human annotators to mark entities and relations that appear in one or more documents. There are a number of types of annotations. A mention annotation annotates a phrase that belongs to a pre-defined type of entity. For example, a phrase “Bill Clinton” that appears in a document can be tagged as a mention (an instance of or a reference to) of the entity “William Clinton” (the actual person in the real world) of type “person.” A coreference annotation links all the mentions that refer to the same entity. For example, a coreference annotation can link all the phrases (e.g. “he”, “Bill Clinton”, “president” etc.) referring to the entity “William Clinton”. A relation annotation marks relations between two mentions, using a number of predefined relations. For example, given the sentence “I visited Italy last year,” the following relation exists: LocatedAt (I, Italy). In other words, the two mentions I and Italy share the LocatedAt relation.

While existing document annotation tools provide a mechanism for annotating documents, they suffer from a number of limitations, which if overcome, could further improve the efficiency and accuracy of document annotation tools. Existing annotation tools do not have the capability of reading in a set of constraints and enforcing them while annotating documents (e.g. mentions of PERSON entities can not be second arguments of LocatedAt relations) to prevent inadvertent incorrect annotations. The user interface elements of the mechanics of annotating mentions, relations and coreference are also deficient in existing annotation tools. For example, some tools lack a mechanism to resize the extent of a mention (e.g. change a mention “The New York Times” to become “The New York Times Company”) without deleting the mention and creating a new mention. For coreference annotation, existing tools lack the ability to merge two entities (i.e. to annotate the fact that these two sets of mentions all refer to the same actual entity) or to even annotate a membership to a specific entity without scrolling through the full list of entities. A need therefore exists for an improved document annotation tool that overcomes one or more of these limitations.

### SUMMARY OF THE INVENTION

Generally, methods and apparatus are provided for annotating documents with one or more of entities, events and relations. According to one aspect of the invention, documents are annotated by presenting the document to a user; presenting the user with a list of possible entity types, wherein the list of possible entity types is configurable; and obtaining at least one mention annotation that associates a selected phrase in the document with one of the possible entity types. The selected phrase can be presented to the user, for example, based on one or more presentation rules associated with the associated entity type. The method can be implemented, for example, in a client-server configuration where a browser communicates with a remote server.

According to another aspect of the invention, a document is annotated by presenting the document to a user; presenting the user with a list of possible relation types, wherein the list of possible relation types is configurable; receiving at least two mention annotations from the user that each associate a selected phrase in the document with a entity type; and obtaining a relation annotation, wherein the relation annotation specifies a relation type between the at least two mention annotations. The relation annotation can comprise, for example, the at least two mention annotations and a time value.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is an exemplary graphical interface for presenting a document for annotation to an annotator;

FIG. 3 is an exemplary graphical interface for annotating mentions in a document in accordance with the present invention;

FIG. 4 is an exemplary graphical interface for annotating relations in a document in accordance with the present invention;

FIG. 5 is an exemplary graphical interface for annotating coreferences in a document in accordance with the present invention;

FIG. 6 illustrates an exemplary set of files that are maintained for each document in accordance with the present invention;

FIG. 7 illustrates an exemplary set of definition files 700 that are employed by the present invention; and

FIG. 8 illustrates the annotation of multiple attributes for a mention, according to one aspect of the invention.

### DETAILED DESCRIPTION OF PREFERRED EMBODIMENTS

The present invention provides methods and apparatus for annotating relations and mentions in documents. According to one aspect of the invention, a graphical toolkit is provided that allows human annotators to mark entities and relations in one or more documents. According to another aspect of the invention, methods and apparatus are provided for visualizing such information in a marked-up document.

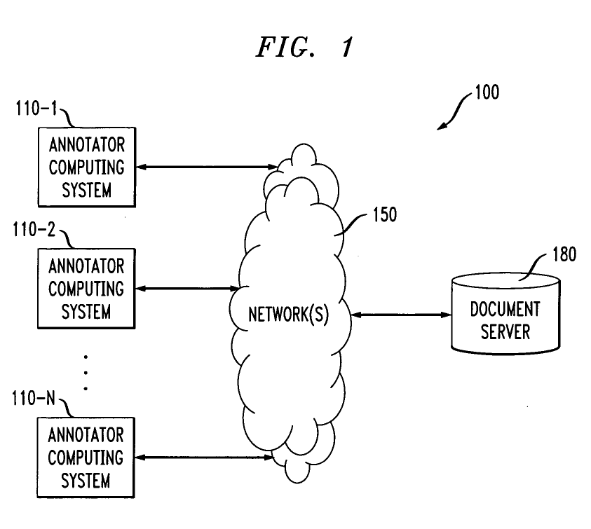

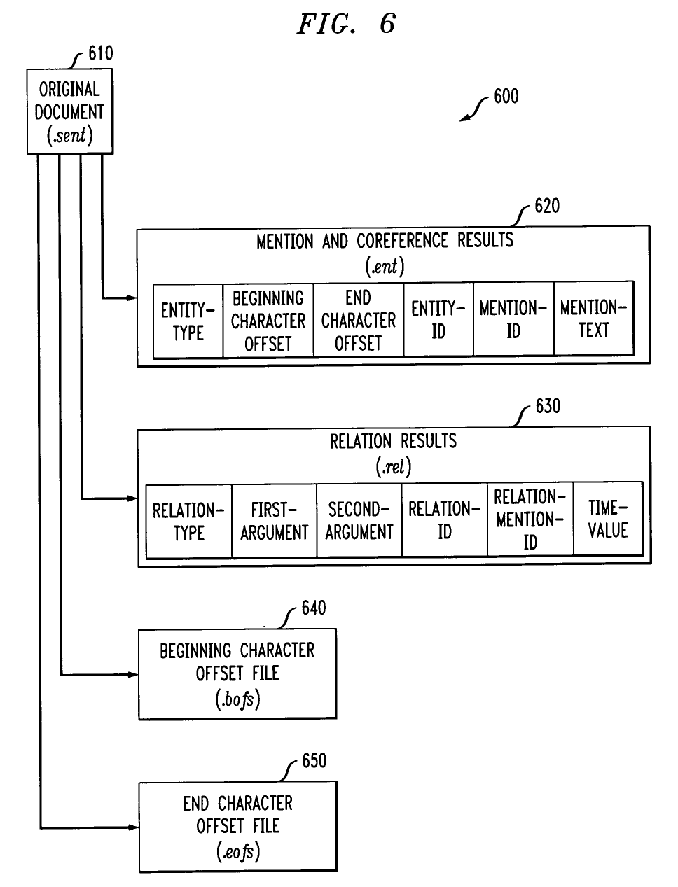

FIG. 1 illustrates a network environment 100 in which the present invention can operate. As shown in FIG. 1, one or more human annotators employ computing devices 110-1 through 110-N, hereinafter collectively referred to as annotator computing devices 110, to access one or more documents over a network 150 from a document server 180. In one exemplary implementation, the human annotators can employ a browser executing on the computing devices 110 to request documents by submitting a Uniform Resource Locator (URL) that identifies a requested document in accordance with the Hypertext Transfer Protocol (HTTP). The manner in which the documents and corresponding annotations generated by the present invention are stored by the document server 180 are discussed further below in conjunction with FIG. 6.

In one implementation, documents to be annotated can be pre-assigned to annotators and presented to the appropriate annotator(s) for annotation, upon a log-in. In a further variation, annotators can be presented with a list of available documents requiring annotation and annotators can then select one or more documents to annotate. The document server 180 can optionally implement existing access control techniques to ensure that only authorized individuals access the various stored documents.

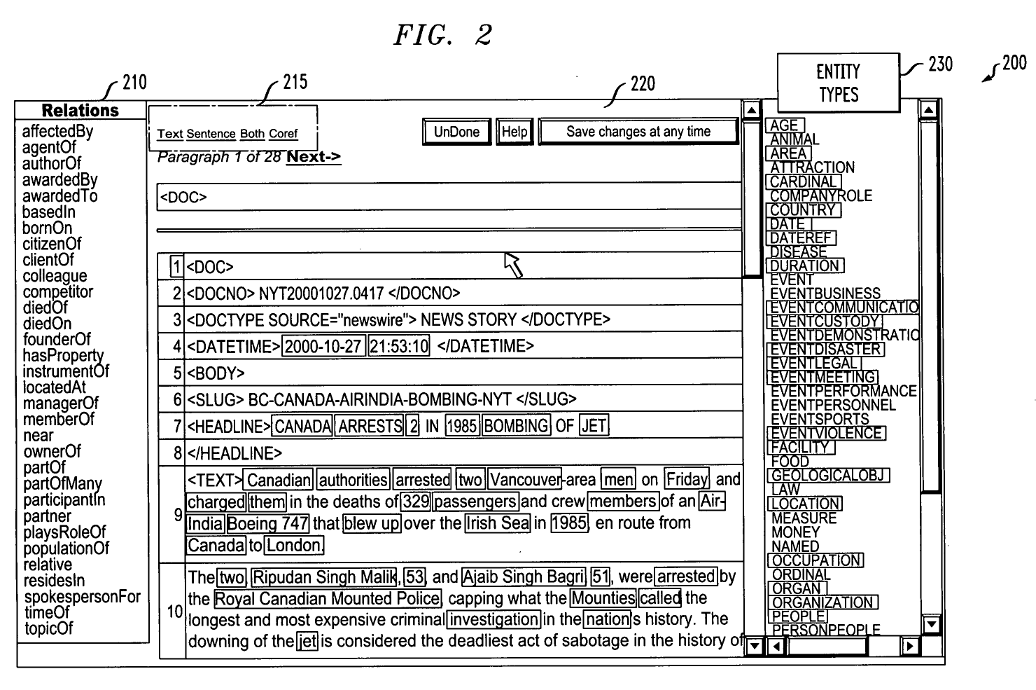

As discussed hereinafter, after selecting a document from the document server 180, the annotator computing device 110 will display the selected document to the human annotator with any existing annotations that have been associated with the selected document. FIG. 2 is an exemplary graphical interface 200 for presenting a document for annotation to an annotator. As shown in FIG. 2, the exemplary graphical interface 200 contains three frames 210, 220, 230. A relation frame 210 lists all possible types of relations; document frame 220 contains the document and an entity type frame 230 lists all possible entity types.

One exemplary implementation of the present invention provides a number of different modes for annotation. The exemplary graphical interface 200 of FIG. 2 provides a mode selection window 215 that allows the annotator to select a text, sentence, both, or coref mode. The mode is selected by clicking on the corresponding button in mode selection window 215. In the text mode, the entire document is displayed. In the sentence mode, only the current sentence is displayed. In the sentence mode, the annotator can go to the previous or next sentence by clicking on the corresponding button. In the both mode, the current sentence is displayed on the top and the complete document is displayed below the current sentence. The sentence and both modes are generally suitable for annotating mentions and relations, while the text mode is only suitable for mention tagging. The coref mode is for annotating coreference relationships between mentions, as discussed further below.

Annotating a Mention

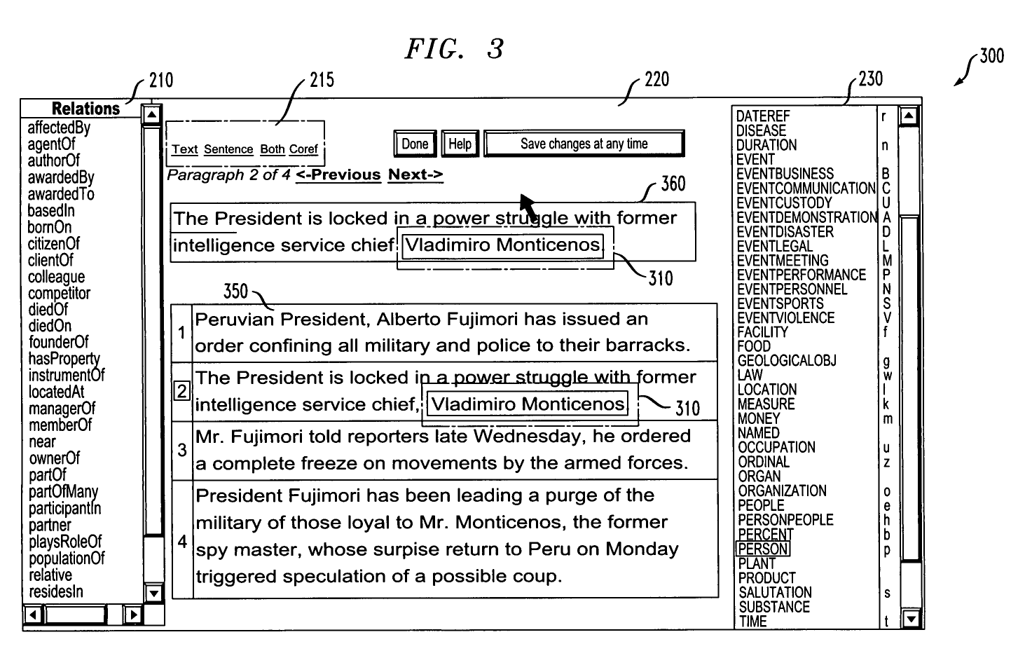

FIG. 3 is an exemplary graphical interface 300 for annotating mentions in a document in accordance with the present invention. As previously indicated, a mention annotation annotates a phrase that belongs to a pre-defined entity category. As shown in FIG. 3, the exemplary graphical interface 300 contains the same three frames 210, 220, 230, as discussed above in conjunction with FIG. 2, for presenting all possible relations; the document and all possible entity types, respectively.

In one exemplary embodiment of the invention, a mention is annotated by clicking on the first word of the phrase to be marked, for example, using a left mouse button. If the phrase contains multiple words, the annotator should also click on the last word of the phrase. FIG. 3 shows the exemplary phrase “Vladimiro Monticenos” 310 selected in this manner. It is noted that the document 350 is presented in the document frame 220, and the sentence currently selected from the document 350 is presented in a sentence window 360.

In the exemplary implementation shown in FIG. 3, a selection box 310 is presented around the selected phrase. Thereafter, the annotator selects an entity type (i.e., category) for the selected phrase from the list of entity types presented in the frame 230. This can be done by either clicking on the appropriate type (shown in the frame 230 on the screen), or optionally typing in a predefined hotkey for that type, if available (the hotkey can be shown on the same line as the corresponding type, usually as a letter or a number). Upon completion, the mention is highlighted, for example, in a color specified for that entity type.

The exemplary graphical interface 300 can optionally include a delete mention button (not shown in FIG. 3) or allow clicking the delete button on the keyboard to allow an annotator to delete a selected mention. In addition, an annotator can optionally change an existing entity type for a selected phrase by clicking on the mention, and choosing the new entity type by clicking on the new entity type in the frame 230 (or optionally typing in the hotkey for the entity type).

According to another aspect of the invention, the phrase associated with a mention can also be resized to encompass additional adjacent words. In one exemplary implementation, the annotator can resize a mention by first selecting the mention to be edited. To increase the size of the mention, the annotator can click on the first or last word of the new mention. To decrease the size of the mention, the annotator can remove a word from the beginning of the mention by clicking on the left-most word, or remove words from the end of the mention by clicking on the right-most word that should remain in the mention. The selection box 310 around the mention should vary as words are added to or deleted from a mention. Likewise, in an implementation where mentions of a given type are presented in a given color, the color presentation should vary as words are added to or deleted from a mention. The boundary of the selection box 310 or colored frame indicates the resized mention. The annotator can optionally complete the resize action, for example, by clicking on a resize mention done button (not shown); pressing the enter key; or clicking on another mention.

According to another character editing mode of the invention, part of a token can be annotated as a mention. For example, assume an annotator wishes to annotate France as COUNTRY in the sentence “I visited France.” Since the last token in the sentence is “France.”, the period that is following the word “France” must be removed. To do this, the exemplary graphical interface 300 can optionally provide a character editing mode that may be accessed, for example, by typing “charEdit=1” in the command line.

A partial token can be annotated as a mention by first annotating the entire token as a mention, in the manner described above. Thereafter, the annotator can optionally remove any extra characters in the token. The annotator can press, for example, ALT+left-mouse-button to select the annotated mention. Once selected, the mention can be highlighted, for example, in a colored frame with double lines. The annotator can then remove characters from the left or right. The boundary of the colored frame can be adjusted to indicate the new mention. Once the annotator is satisfied with the new mention, the editing can be completed, for example, by clicking on a resize mention done button (not shown), pressing the enter key, or clicking on another mention, in a similar manner to the completion of the resize action discussed above.

Annotating Relations

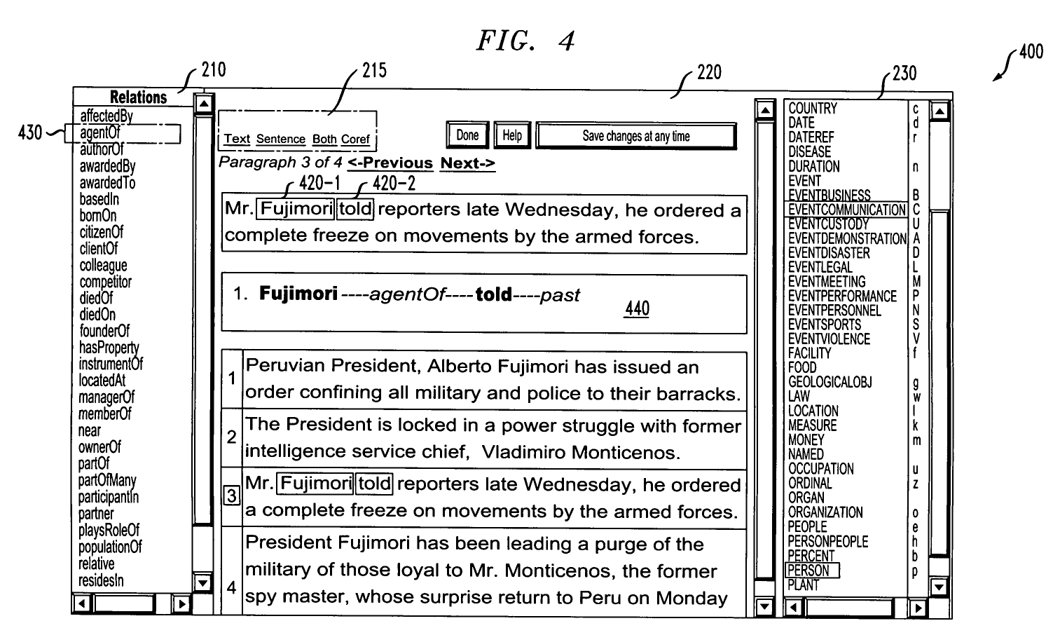

FIG. 4 is an exemplary graphical interface 400 for annotating relations in a document in accordance with the present invention. As previously indicated, a relation annotation marks relations between two mentions, using a number of predefined relations. As shown in FIG. 4, the exemplary graphical interface 400 contains the same three frames 210, 220, 230, as discussed above in conjunction with FIG. 2, for presenting all possible relations; the document and all possible entity types, respectively.

Relations are annotated in the sentence or both mode, as selected in the mode selection window 215. A relation has two arguments, such as two mentions within the same sentence, and a time value (such as past, current, future, unknown, and hypothetical). Some relations are symmetric, so it may be important to pay attention to the order of the arguments when annotating relations.

As shown in FIG. 4, a relation is annotated by selecting the first and second arguments 420-1 and 420-2, for example, by clicking on the mentions. All the relation types that can have the selected mention as the arguments are highlighted in the left frame 210 on the screen. Thereafter, a relation type 430 is selected from the possible relation types in frame 210 by clicking on the desired relation type 430. In an exemplary implementation, as the relation is annotated, the relation is presented in a window 440 below the current sentence. Once the arguments 420-1 and 420-2 are selected, the potential relation types 430 and time values can be presented in a pull-down list in the window 440.

The arguments of a relation can be highlighted, for example, by moving the cursor to the relation and placing the cursor over the relation name (which is between the two arguments for the relation). The relation arguments will be highlighted in the current sentence. A relation can be deleted by positioning the cursor over the current relation, and clicking on the relation name. A pop-up window can optionally be presented to confirm that the annotator wants to delete the relation.

The time value of a relation can be modified, for example, by positioning the cursor over the time value to be edited, and clicking on it. A pull-down list can be presented with a list of available time values.

Annotating Coreferences

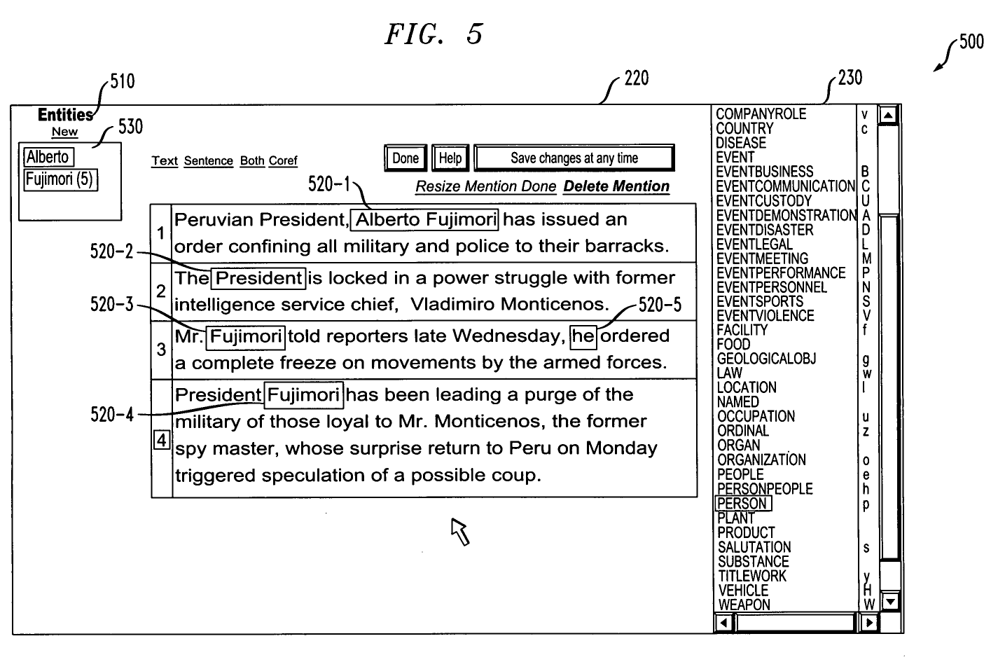

FIG. 5 is an exemplary graphical interface 500 for annotating coreferences in a document in accordance with the present invention. As previously indicated, a coreference annotation links mentions that refer to the same entity. As shown in FIG. 5, the exemplary graphical interface 500 contains the same frames 220, 230, as discussed above in conjunction with FIG. 2, for presenting the document and all possible entity typesentity types, respectively. The left frame 510, however, in the exemplary graphical interface 500 presents all the entities that have been formed so far, as discussed hereinafter.

Coreferences are annotated in the coref mode, as selected in the mode selection window 215. Generally, the coreference step merges all the mentions that refer to the same entity. In the coref mode, the left frame 510 presents all the entities that have been formed so far. Each entity is presented by a mention belonging to that entity, followed by the total number of mentions belonging to that entity (the number is in parentheses). For example, the exemplary entity “Fujimori” selected in FIG. 5 has a total of five mentions 520-1 through 520-5. Clicking on any entity in the frame 510 will highlight all the corresponding mentions 520 in the document frame 220 belonging to the selected entity. Likewise, clicking on any mention 520 in the document frame 220 will highlight the entity that the mention belongs to and also all the other mentions 520 that belong to the same entity. Each entity is referred to as a coreference chain, with all the mentions in the same entity chained together. Before any coreference action is performed, each mention is a separate coreference chain.

A mention 520 can be added to a coreference chain, for example, by selecting the mention to be added, and indicating the coreference chain to which the selected mention should be added. For example, the annotator can employ the exemplary graphical interface 500 by selecting a target coreference chain (i.e., entity) in the left frame 510; and selecting one of the mentions belonging to the entity in the document frame 220. Thereafter, the number of mentions 520 belonging to the selected target entity (shown in the left frame 510 in parentheses) has increased by one. When the newly added mention is selected, the newly added mention should be highlighted together with all the other mentions of the target entity.

A mention 520 can be removed from a coreference chain, for example, by selecting the mention and then clicking on a new button 530 in left frame 510. In this manner, the mention is separated from a coreference chain to which the mention was previously joined. According to another feature of the exemplary graphical interface 500, two coreference chains, each of which contains one or more mentions, can be merged together. Two coreference chains can be merged, for example, by selecting a mention in the first coreference chain, selecting a mention in the second coreference chain, and initiating a predefined command key sequence, such as CTRL+left-mouse-button. In this manner, all the mentions in the selected coreference chains are merged into a single coreference chain. For example, if the two coreference chains have three and two mentions, respectively, the merged chain will have five mentions.

If an annotator has already formed two coreference chains, each of which contains more than one mention, a mention can be moved from one coreference chain to another chain, for example, by selecting the mention to be moved, and positioning the cursor over a mention in the target coreference chain, and initiating a predefined command key sequence, such as ALT+left-mouse-button. In this manner, a single mention is moved to the target coreference chain. For example, if a first coreference chain has three mentions, and a second coreference chain has two mentions, moving one mention from the second chain to the first chain will result in four mentions in the new first coreference chain and one mention in the new second coreference chain.

Storage of Document and Associated Annotations

In one exemplary implementation, the document server 180 stores the annotation results in the same directory as the original document. FIG. 6 illustrates an exemplary set of files 600 that are maintained in accordance with the present invention. As shown in FIG. 6, the original document 610 is stored with the extension .sent. The corresponding mention and coreference results created in accordance with the present invention can be stored in .ent files 620, and the relation results can be stored in a .rel file 630.

As shown in FIG. 6, each line in the .ent files 620 represents an annotated mention. The fields from left to right in the ent files 620 are: entity-type, the beginning character offset in the document of the mention, the end character offset, entity-id, mention-id, and mention-text. It is noted that mentions that are in the same coreference chain have the same entity-id.

Each line in the .rel files 630 represents an annotated relation. The fields from left to right in the rel files 630 are: relation-type, first-argument (represented by its mention-id in the ent file), second-argument, relation-id, relation-mention-id, time-value. In addition, the exemplary annotation tool creates a beginning character offset file 640, .bofs and an end character offset file 650, .eofs. The .bofs files contain the beginning character offset of each token in the original sent files, and the .eofs files contain the end character offsets.

In other embodiments of the invention, all the annotations are stored in a XML file with different XML elements (e.g., “<mention>” and “<offset>”) to represent all the information being stored.

Configuration Files

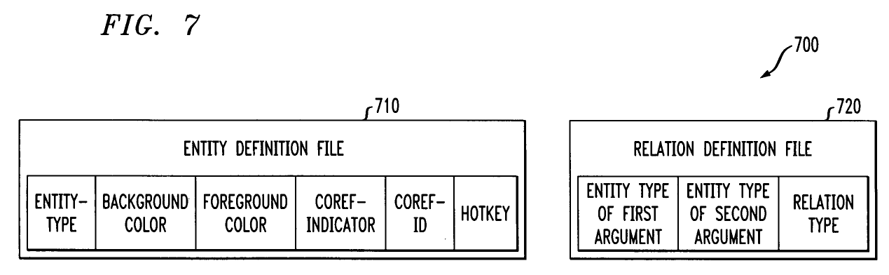

FIG. 7 illustrates an exemplary set of definition files 700 that are employed by the present invention. The exemplary embodiment of the disclosed annotation tool also employs two definition files 710, 720. An entity definition file 710 specifies the entity types and a relation definition file 720 specifies the relation types.

As shown in FIG. 7, the entity definition file 710 is given as the colormap parameter in the command line. Each line in the exemplary file 710 contains the following fields: entity type, background color, foreground color, coref-indicator, coref-ID and hotkey. In this manner, each entity type is separately configurable. In an exemplary implementation, a coref-indicator of “1” indicates that coreference should be annotated for this type of entity, and a value of “0” indicates that coreference need not be annotated (for instance, coreference for mentions tagged as MONEY are not annotated). It is again noted that entity types assigned with the same Coref-ID number can be merged. For example, the annotation tool can be configured to allow (or disallow) the coreference annotation of “SALUTATION” entities with “PERSON” entities (i.e. to allow annotation of a “Mr.” (type: SALUTATION) to corefer to a “Clinton” mention (type: PERSON)). The hotkey field specifies the character used as a hotkey for setting mention type.

The exemplary relation definition file 720 is given as the re/s parameter in the command line. Each line in the exemplary file 720 contains the following fields: entity type of the first argument, entity type of the second argument and relation type, representing an allowed combination of entity and relation types. Any combination not specified in this file is automatically disallowed by the annotation tool.

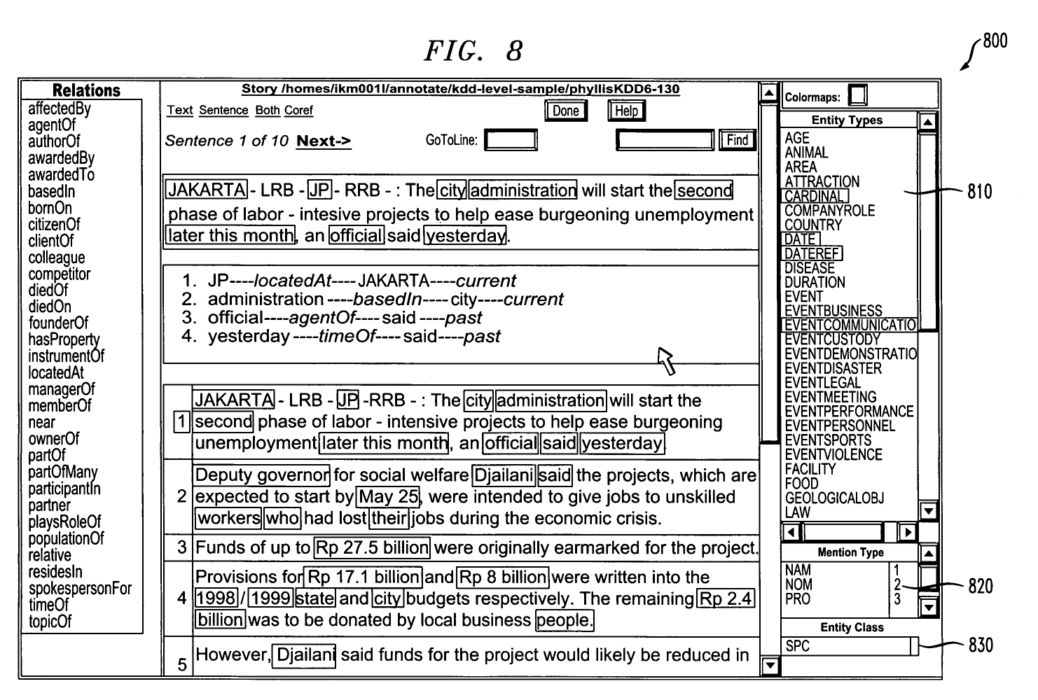

FIG. 8 illustrates the annotation of multiple attributes for a mention, according to one aspect of the invention. As shown in FIG. 8, one embodiment of the invention includes additional subframes 810, 820, 830 on the right hand side for each level of annotation. After the initial annotation, the annotator selects the level he or she wants to annotate from the subframe 820, the corresponding color map gets activated in the display 800 and the annotator then annotates the types relevent to that level of annotation (in an exactly identical fashion (for example, same key strokes) to the standard mention annotation).

A mention can have two additional attributes in addition to its category type. The two additional attributes are mention type 820 and entity class 830. To annotate a mention in the multiple attribute mode, the annotator clicks on a mention in the main window 800, and then selects a value from each colormap on the right hand side of the annotation page. A screen shot of the multiple attribute annotation is shown in FIG. 8.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A method for annotating a document, comprising:
presenting said document to a user;
presenting said user with a list of possible entity types, wherein said list of possible entity types is configurable; and
obtaining at least one mention annotation that associates a selected phrase in said document with one of said possible entity types.

2. The method of claim 1, wherein said selected phrase is presented to said user based on one or more presentation rules associated with said associated entity type.

3. The method of claim 1, wherein said presentation rules define a color for presenting phrases associated with said associated entity type.

4. The method of claim 1, wherein each of said possible entity types may be configured to selectively allow coreference annotations.

5. The method of claim 1, wherein said at least one received mention annotation has an associated entity identifier.

6. The method of claim 1, wherein said at least one received mention annotation has one or more associated offsets into said document.

7. The method of claim 1, wherein said at least one received mention annotation has an associated entity identifier and may be linked to coreferences having the same entity identifier.

8. The method of claim 1, further comprising the step of receiving one or more coreference annotations that link a plurality of said mention annotations that refer to the same entity.

9. The method of claim 1, further comprising the step of generating an output file in a desired format.

10. The method of claim 1, wherein at least one of said presenting steps is performed by a browser communicating with a remote server.

11. The method of claim 1, wherein said at least one mention annotation can be resized to add or remove one or more adjacent words.

12. A method for annotating a document, comprising:
presenting said document to a user;
presenting said user with a list of possible relation types, wherein said list of possible relation types is configurable;
receiving at least two mention annotations from said user that each associate a selected phrase in said document with a entity type; and
obtaining a relation annotation, wherein said relation annotation specifies a relation type between said at least two mention annotations.

13. The method of claim 12, wherein said relation annotation comprises said at least two mention annotations and a time value.

14. The method of claim 13, further comprising the step of presenting possible time values to said user.

15. The method of claim 12, further comprising the step of presenting the possible relation types to said user that can have said at least two mention annotations as arguments.

16. The method of claim 15, wherein said possible relation types are presented to said user in a menu.

17. The method of claim 12, further comprising the step of presenting said relation annotation to said user.

18. The method of claim 12, further comprising the step of highlighting selected mention annotations.

19. A system for annotating a document, comprising:
a memory; and
at least one processor, coupled to the memory, operative to:
present said document to a user;
present said user with a list of possible entity types, wherein said list of possible entity types is configurable; and
obtain at least one mention annotation that associates a selected phrase in said document with one of said possible entity types.

20. A system for annotating a document, comprising:
a memory; and
at least one processor, coupled to the memory, operative to:
present said document to a user;
present said user with a list of possible relation types, wherein said list of possible relation types is configurable;
receive at least two mention annotations from said user that each associate a selected phrase in said document with a entity type; and
receive a relation annotation from said user, wherein said relation annotation specifies a relation type between said at least two mention annotations.
